(19) United States
(12) Patent Application Publication
(10) Pub. No.: US 2012/0086324 A1
(43) Pub. Date: Apr. 12, 2012

(54) LAMP UNIT

(75) Inventor: Alex Voronov, Hanau (DE)

(73) Assignee: HERAEUS NOBLELIGHT GMBH, Hanau (DE)

(21) Appl. No.: 13/377,964

(22) PCT Filed: May 17, 2010
(86) PCT No.: PCT/EP2010/002999

§ 371 Date: Dec. 13, 2011

(30) Foreign Application Priority Data
Jun. 17, 2009 (DE) 10 2009 025 667.9

(51) Int. Cl. H01J 65/04

(52) U.S. Cl. 313/113

(57) ABSTRACT

A lamp unit includes a mercury vacuum lamp and a reflector, wherein a discharge chamber containing a filling gas extends along the longitudinal axis of the lamp unit. In order to provide a lamp unit comprising particularly high power and power density and high efficiency of UVC emission on the basis thereof, the discharge chamber forms a circumferential ring gap (6) or an interrupted ring gap, bounded by a radiating shell (8) and a reflector shell (9) associated with the reflector (5).

### CROSS-REFERENCE TO RELATED APPLICATIONS

This application is a Section 371 of International Application No. PCT/EP2010/002999, filed May 17, 2010, which was published in the German language on Dec. 23, 2010, under International Publication No. WO 2010/145739 A1 and the disclosure of which is incorporated herein by reference.

### BACKGROUND OF THE INVENTION

Embodiments of the invention relate to a lamp unit comprising at least one mercury vacuum lamp and at least one reflector, wherein a discharge chamber containing a filling gas extends along the longitudinal axis of the lamp unit.

Lamp units comprising at least one mercury vacuum lamp and at least one reflector are used extensively for lighting purposes and for UV applications, such as tanning, for UV disinfection, or for activation of chemical reactions. The excitation of the filling gas takes place by electrodes protruding into the discharge chamber or electrodeless by capacitive, inductive or microwave-supported excitation.

Mercury vacuum lamps are characterized by a high efficiency of about 40% for the conversion of electrical energy into UVC radiation. This results in typical powers of modern mercury vacuum lamps of 100 W and power densities of 1 W/cm.

A further increase in power density while maintaining the high efficiency can be achieved theoretically by increasing the operating current with simultaneous increase of the lamp diameter. The increase of the lamp diameter has a physical limitation called “self absorption”.

The “self-absorption” is due to interactions of the UVC photons with the mercury atoms in the filling gas atmosphere and is noticed as a decrease in intensity and efficiency of the UV emission, respectively, both at too high mercury concentrations and too long path lengths of the UVC photons within the discharge chamber.

An increase of the operating current is applied to so-called amalgam lamps. The nominal operating current of a mercury vacuum lamp is usually designed for optimum mercury concentration in the discharge chamber, and therefore maximum UVC intensity. Exceeding the nominal operating current causes an increase in temperature and thus of the mercury concentration in the filling gas, which, in turn, leads to increased self-absorption and thus to a reduction in UVC intensity.

In amalgam lamps, mercury is introduced into the discharge chamber in the form of an amalgam alloy. The binding of mercury in the amalgam acts contrary to its release into the discharge chamber. This allows for higher operating currents (higher temperatures), so that three to six times higher power and power densities may be achieved compared with conventional mercury vacuum lamps. Even with amalgam lamps, any further increase of the operating current beyond the optimal value leads to higher losses due to self-absorption.

Increasing the lamp diameter results in a better cooling of the lamp by the larger lamp diameter, which would theoretically allow for a higher operating current while maintaining an optimum mercury concentration in the gas filling. On the other hand, an increase of the lamp diameter also leads to an increase in path length for UVC photons, so that they are absorbed with higher probability and, consequently, the UVC power decreases by “self-absorption”.

Therefore there is a physically meaningful maximum size of the lamp diameter, which is at about 38 mm for currently commercially available mercury vacuum lamps.

### BRIEF SUMMARY OF THE INVENTION

It is desirable to provide a lamp unit with particularly high power and power density, and efficiency of the UVC radiation.

Based on a lamp unit of the above-mentioned type, this is achieved by embodiments of the present invention in that the discharge chamber forms a circumferential ring gap or an interrupted ring gap bounded by a radiating shell and a reflector shell associated with the reflector.

In the lamp unit according to the invention, the radial cross section of the discharge chamber (viewed in the direction of the longitudinal axis of the lamp unit) is not configured as circle-shaped as usual, rather it is ring-shaped. For example, as a ring with round, oval or polygonal cross-section.

At least over most of its length the discharge chamber forms either a uniform, continuous chamber in the form of a closed, circumferential ring gap, or it comprises several sub-chambers each extending along the longitudinal axis of the lamp unit.

In the first case, the lamp unit according to embodiments of the invention comprises only a single mercury vacuum lamp with a ring-shaped discharge chamber.

In the second case, each of the discharge chamber sub-chambers may be associated with a mercury vacuum lamp. The discharge chamber sub-chambers (or the mercury vacuum lamps) comprises, for example, hollow cylindrical elements. They are arranged around the longitudinal axis of the lamp unit, such that they form the radially interrupted, approximately ring gap-shaped discharge chamber. Here, each sub-chamber may be associated with its own reflector, or sub-chambers can share one or more reflectors.

Overall, the discharge chamber has—at least approximately—the form of a hollow cylinder. One of the two cylinder shells of the discharge chamber forms the radiating shell through which the UV radiation is emitted. The reflector is assigned to the other cylinder shell. It is configured, for example, as a reflector or it is bounded by a reflective medium. This cylinder shell forms the reflector shell in the sense of the invention. The UVC photons emitted in the direction of the reflector are reflected back, and thus are not lost, but instead contribute to the UVC flux.

Compared to the normal discharge chamber geometry, the hollow cylindrical, ring gap-shaped discharge chamber allows for a larger discharge chamber volume of the lamp unit according to embodiments of the invention, which is determined by its outer diameter at a given width of the discharge chamber. The larger volume allows application of a higher operating current and thus a higher power and power density of the lamp unit according to embodiments of the invention (while maintaining an optimal concentration of mercury in the filling gas).

At the same time, the width of the ring gap-shaped discharge chamber can be kept so small that the effect of “self absorption” by increasing the path length for the UVC photons is largely avoided. For each parameter pair “outer diameter of the discharge chamber/gap width of the discharge chamber” there is an optimum for the operating current, which can be determined based on just a small number of experiments.

In addition, the relatively larger outer diameter of the discharge chamber and the additional inner wall lead to a significant increase in free lamp surface, resulting in a more effective cooling of the lamp unit. A more effective cooling counteracts a temperature increase during operation and thus also allows for a higher operating current, without exceeding the optimal concentration of mercury in the filling gas.

The walls bounding the ring gap to the inside and the outside (radiating shell and reflector shell) may have the same cross-sectional geometry, or they may differ in their cross-sectional geometries. In the simplest case, the cross-sectional geometries are the same and the walls run coaxially with each other, so that the ring gap has the same gap width everywhere.

The reflector adjacent to the discharge chamber is configured either as a separate component or as a coating in the area of the reflector shell.

The reflector may be provided at the outside of the discharge chamber, whereby the inner wall serves as radiating shell and the lamp unit acts as a cylindrical, inward-radiating “inside radiator.” Another preferred embodiment provides that the ring gap has an inner wall configured as a reflector shell.

The discharge chamber has an outward-pointing, closed or interrupted radiating shell, through which the UV work radiation exits to the outside. Opposite to it there is provided an inward-pointing, closed or interrupted reflector shell adjacent to a reflector. The reflector is configured either as a separate component or as a coating in the region of the reflector shell.

Preferably, the ring gap-shaped discharge chamber has a gap width of at maximum 40 mm, preferably at maximum 35 mm.

The larger the gap width of the discharge chamber—at a given inner diameter—, the larger is the discharge chamber volume and thus the optimum operating current and the achievable UVC flux. At gap widths of more than 40 mm, however, a marked decrease in UVC power occurs due to “self-absorption.”

In terms of a highest possible discharge chamber volume and a highest possible optimal operating current, and thus a high UVC flux, it has proved advantageous if the ring gap-shaped discharge chamber has a mean gap width of at least 10 mm, preferably at least 15 mm.

The lamp unit according to embodiments of the invention having a ring gap-shaped discharge chamber and adjacent reflector exhibits, for the above-mentioned reasons, a positive effect on power and efficiency of UVC radiation even at a low inner diameter of the ring gap. On the other hand, compared with conventional lamps, the production of the lamp unit according to embodiments of the invention requires a certain additional structural cost, which is economically justified only by a significant increase of UVC power. For a given ring gap (which is limited by self-absorption due to increasing path length of the UVC photons) a large inner diameter of more than 10 mm leads to a marked increase of the discharge volume without increasing the self-absorption. Therefore, the largest possible internal diameters of the mercury vacuum lamp are preferred.

In this context, preferred outer diameters of the mercury vacuum lamp are larger than 20 mm, preferably larger than 35 mm.

A reflector made of a dielectric material is advantageous, especially for electrodeless excitation of the filling gas (by microwave or by capacitive or inductive excitation). Therefore, in a preferred embodiment of the mercury vacuum lamp according to the invention, a reflector comprising a dielectric material is preferred.

In this context, a reflector configured as a reflective layer of opaque quartz glass is particularly useful.

Here, the reflection characteristics are based on “diffuse reflection.” It has been shown that reflectances are achievable which are comparable with those of metallic reflectors, when reflective layers of opaque quartz glass are used in certain wavelength ranges.

In a particularly preferred embodiment of the mercury vacuum lamp of the invention, it is provided that the discharge chamber is configured as a circumferential ring gap between an outer tube and an inner tube.

The inner tube is arranged coaxially or eccentrically with the outer tube. The cross-sectional geometries of the inner tube and outer tube are the same or different and may be, for example, round, oval or polygonal. The discharge chamber as a circumferential, closed ring gap between tubes is particularly easy to implement.

In this context it has proved advantageous to provide a device for an electrodeless excitation of the filling gas.

A coaxial or eccentric arrangement of inner tube and outer tube requires either a special adaptation of the electrode shape to the internal geometry of the discharge chamber or a special design of the discharge chamber in the area of the electrodes, for example, a circular section of the discharge chamber. This expense does not apply in the case of an electrodeless excitation of the filling gas.

Preferably, the reflector adjacent to either the inner tube or the outer tube is provided on the side of the tube facing away from the discharge chamber.

In that case, the reflector material facing away from the discharge chamber is not exposed to the discharge in the discharge chamber and does not contaminate the filling gas.

An alternative and equally preferred embodiment of the lamp unit of the invention provides a discharge chamber that is a radially interrupted ring gap comprising a plurality of mercury vacuum lamp modules, which are arranged around the longitudinal axis of the lamp unit, so that its longitudinal cylinder axis runs parallel to the longitudinal axis of the lamp unit.

The ring gap is interrupted and its ring shape is approximated by the ring-shaped arrangement of the discharge chambers of the individual lamp modules. Here, the lamp modules surround the longitudinal axis of the lamp unit.

In the simplest case, the lamp modules are configured identically, constructed as mercury vacuum lamps having a conventional cylindrical discharge chamber, for example having a discharge chamber with a circular or polygonal cross-section. In cross section (viewed in the direction of the lamp axis) the ring-shaped arrangement of the lamp modules forms approximately a circular ring, an oval or a polygon. To this extent, this corresponds to the closed ring gap-shaped discharge chamber described above. The individual lamp modules can be mounted on a frame or they can be connected with each other, for example by gluing or welding, and therefore are fixed in the ring shape.

The surface area of the respective lamp module wall facing the longitudinal axis of the lamp acts either as a reflector shell or as a radiating shell. The surface area acting as reflector shell is provided with a reflective layer or it is adjacent to a reflector. Each surface area opposite to the respective lamp module wall acts as a radiating surface.

In this embodiment, preferably, a reflector is provided that is configured as a separate component by the lamp modules surrounding a cylindrical inner space, in which a cylindrical reflector component is seated, for example in the form of a rod or tube.

The lamp unit according to the invention serves in particular to provide very high UVC power and UVC power densities. To achieve this, in a preferred embodiment of the lamp unit the at least one mercury vacuum lamp is configured as an amalgam lamp.

The lamp unit according to the invention is characterized by high power densities of preferably at least 5 W/cm, more preferably at least 10 W/cm.

The unit W/cm refers to the length of the lamp unit viewed in the direction of its longitudinal axis.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a radial cross section of a first embodiment of the mercury vacuum lamp according to the invention having a circumferential discharge chamber,

FIG. 2 shows a radial cross section of an embodiment of the mercury vacuum lamp according to the invention having an interrupted discharge chamber,

FIG. 3 shows another embodiment of the mercury vacuum lamp according to the invention having an interrupted discharge chamber in a radial cross-section, and

FIG. 4 shows a radial cross section of another embodiment of the mercury vacuum lamp according to the invention having a circumferential discharge chamber.

### DETAILED DESCRIPTION OF THE INVENTION

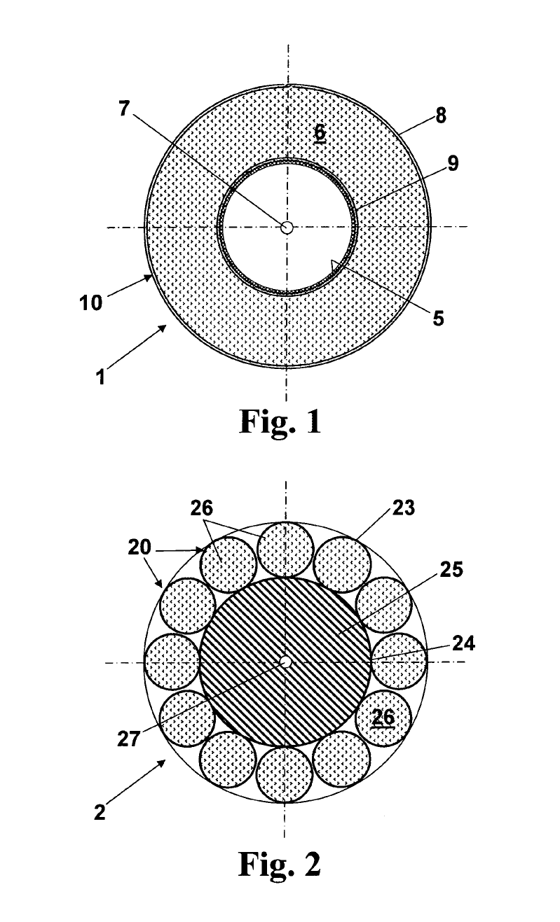

The lamp unit 1 according to FIG. 1 comprises an amalgam lamp 10 and a reflector 5. The amalgam lamp 10 has an outer tube 8, in which an inner tube 9 is arranged coaxially with the longitudinal axis 7 of the lamp unit. Outer tube 8 and inner tube 9 are fused together at the front-ends, creating, in the illustrated cross-section, a vacuum-tight circumferential ring gap between the outer tube 8 and the inner tube 9, which forms the discharge chamber 6 of the amalgam lamp 10. An appendix (not shown) containing mercury atoms in an amalgam alloy is welded to the discharge chamber 6 in the usual way. The filling gas is excited by microwaves or inductively by high frequency. The longitudinal axis 7 of the lamp unit 1 runs perpendicular to the paper plane.

The inner tube 9 is made of quartz glass and, on the inner surface facing away from the discharge chamber 6, is provided with a reflective layer 5. On the inner wall of the inner tube 9 the reflective layer 5 is configured in the form of a 0.5 mm thick layer of opaque, synthetic quartz glass. For reasons of clarity of illustration, the thickness of the reflective layer in FIG. 1 is shown exaggerated in size.

The inner tube 9 has an outer diameter of 28 mm (wall thickness: 1.5 mm). The outer tube 8 is also made of quartz glass and has an inner diameter of 51 mm (wall thickness: 2 mm). Thus, the discharge chamber 6 has a radially uniform gap width of about 11.5 mm.

The cylindrical outer surface of the outer tube 8 forms an outward-pointing, closed radiating shell, through which the UV work radiation exits to the outside, and the inner tube 9 forms the reflector shell in the sense of the invention.

Compared to a conventional mercury vacuum lamp with a cylindrical discharge chamber of the same inner diameter (11.5 mm), a lamp unit 1 according to an embodiment of the invention is obtained where the discharge chamber 6 has a larger volume and the discharge chamber 6 has a larger free surface.

Therefore, in comparison to conventional mercury vacuum lamps, with the same width of the discharge area, the operating current optimized by taking into account the “self absorption,” and thus the number of UVC photons-emitting atoms, can be increased. This leads to particularly high power, power density and efficiency of the UVC radiation. A contributing factor is that the UVC photons emitted in the direction of the reflector layer 5 are reflected back, and thus are not lost completely.

In the embodiment of the lamp unit 2 according to the invention illustrated in FIG. 2, the discharge chamber 26 is configured as an interrupted ring gap. Here, the discharge chamber 26 comprises a plurality (in the embodiment: twelve) of cylindrical lamp modules 20, which are fixed on a frame on their front-ends, so that each of their longitudinal cylinder axes runs parallel to the longitudinal axis 27 of the lamp. The lamp modules 20 together form a radially interrupted, circular arrangement around the longitudinal axis 27 of the lamp unit.

The lamp modules 20 are identically constructed mercury vacuum lamps (amalgam lamps) having a conventional, cylindrical discharge chamber having a typical length up to 2 m and a typical outer diameter ranging from 15 mm to 8 mm, in the embodiment an outer diameter of 22 mm.

In cross section (viewed in the direction of the longitudinal axis 27 of the lamp unit) the arrangement of the lamp modules 20 forms a radial interrupted circular ring having a clear width of about 20 mm, wherein the outward-pointing surface areas indicated by reference numeral 23 of the individual lamp modules 20 act as a radiating surface, and the opposite surface areas 24 as a reflector surface.

Here, the reflector is formed by an aluminum cylinder, which is in contact with the lamp modules 20.

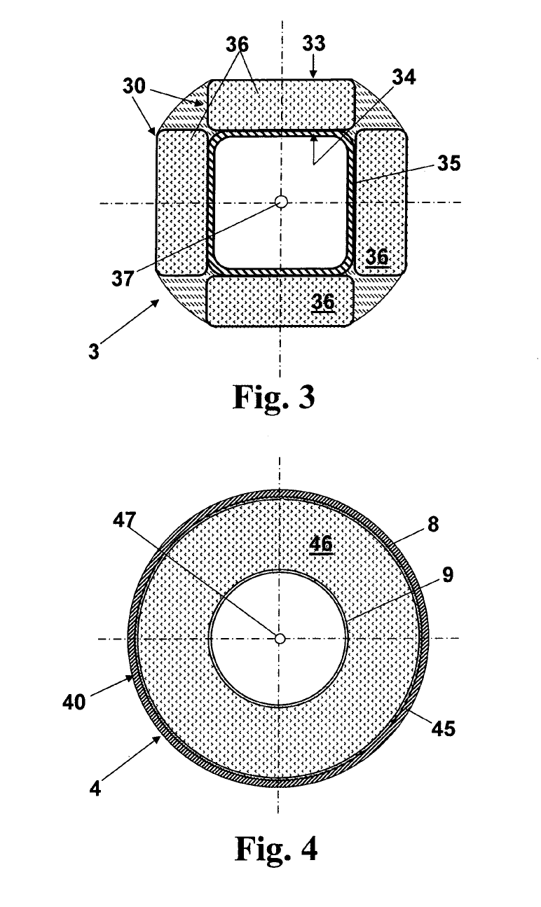

FIG. 3 shows another embodiment of a lamp unit 3 having an interrupted discharge chamber 36. Here, the interrupted discharge chamber 36 comprises four flood lamps 30 arranged in a rectangular fashion. The flood lamps 30 are connected with each other, in the embodiment by gluing together. Each of the longitudinal cylinder axes of the lamp modules 30 runs parallel to the longitudinal axis 37 of the lamp unit.

The flood lamps 30 are identically constructed mercury vacuum lamps (mercury lamps), each having a rectangular discharge chamber with the dimensions 12 mm×28 mm (height×width) and with a typical length of 1 m to 2 m, in the exemplary embodiment, 1.5 m. The outward-pointing surface areas 33 act as a radiating surface and the opposite surface areas 34 as reflector surface. Here, the reflector is formed by an aluminum hollow profile 35 having an edge length of about 30 mm, which is in contact with the lamp modules 30.

FIG. 4 shows another embodiment of a lamp unit 4 according to the invention which is substantially formed from an amalgam lamp 40 having a circumferential, ring gap-shaped discharge chamber 46 and a reflector 45. The discharge chamber 46 is configured as a ring gap between an outer tube 8 and an inner tube 9 seated therein, coaxially with the longitudinal axis 47 of lamp unit.

The lamp unit 4 differs from the embodiment described in FIG. 1 only in that the reflector 45 is provided on the cylinder shell of the outer tube facing away from the discharge chamber 46. The reflector 45 is configured in the form of a 0.5 mm thick layer of opaque, synthetic quartz glass (the thickness of the reflector layer 45 is shown exaggerated in size).

Thus, the outer surface of the cylinder of the outer tube 48 forms the reflector shell in the sense of the invention, and the inner tube 9 forms an inward-pointing, closed radiating shell, through which the UV work radiation exits to the inside.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. -14. (canceled)

15. A lamp unit comprising at least one mercury vacuum lamp and at least one reflector, wherein a discharge chamber comprising a filling gas extends along a longitudinal axis of the lamp unit, wherein the discharge chamber forms a surrounding circumferential ring gap or an interrupted ring gap, bounded by a radiating shell and a reflector shell associated with the reflector.

16. The lamp unit according to claim 15, wherein the ring gap has an inner wall formed as a reflector shell.

17. The lamp unit according to claim 15, wherein the ring gap-shaped discharge chamber has a gap width of at maximum 40 mm.

18. The lamp unit according to claim 17, wherein the ring gap-shaped discharge chamber has a gap width of at maximum 35 mm.

19. The lamp unit according to claim 15, wherein the ring gap-shaped discharge chamber has a mean gap width of at least 10 mm.

20. The lamp unit according to claim 19, wherein the ring gap-shaped discharge chamber has a mean gap width of at least 15 mm.

21. The lamp unit according to claim 15, wherein the ring gap has an inner wall, which runs surrounding the longitudinal axis of the lamp unit, having an inner diameter of at least 10 mm.

22. The lamp unit according to claim 21, wherein the inner diameter is at least 20 mm.

23. The amp unit according to claim 15, wherein the reflector comprises a dielectric material.

24. The lamp unit according to claim 23, wherein the reflector is configured as a reflective layer made of opaque quartz glass.

25. The lamp unit according to claim 15, wherein the discharge chamber is configured as a ring gap between an outer tube and an inner tube.

26. The lamp unit according to claim 25, wherein the reflector is provided on the side of the tube facing away from the discharge chamber.

27. The lamp unit according to claim 15, wherein the discharge chamber is a radially interrupted ring gap comprising a plurality of cylindrical mercury vacuum lamp modules, which are arranged around the longitudinal axis of the lamp unit, such that its longitudinal cylinder axis runs parallel to the longitudinal axis of the lamp unit.

28. The lamp unit according to claim 27, wherein the lamp modules surround a cylindrical inner space in which a cylindrical reflector component is seated.

29. The lamp unit according to claim 15, wherein the at least one mercury vacuum lamp is configured as an amalgam lamp.

30. The lamp unit according to claim 15, wherein the lamp unit is configured for an electrodeless excitation of the filling gas.

31. The lamp unit according to claim 15, wherein the lamp unit has a power density of at least 5 W/cm.

32. The lamp unit according to claim 31, wherein the lamp unit has a power density of 10 W/cm.
